(19) United States
(12) Patent Application Publication
(10) Pub. No.: US 2026/0317168 A1
(43) Pub. Date: Oct. 15, 2026

(54) PROCESS AND PLANT FOR PRODUCING HYDROGEN BY STEAM REFORMING OF A HYDROCARBON-CONTAINING FEED GAS

(71) Applicant: L'Air Liquide, Societe Anonyme pour l'Etude et l’Exploitation des Procedes Georges Claude, Paris (FR)

(72) Inventors: Umberto ROSSI, Frankfurt (DE); Dieter ULBER, Frankfurt (DE); Mirko HUEBEL, Frankfurt (DE); Jakub KUZNIAR, Frankfurt (DE); Tobias KAISER, Frankfurt (DE); Alexander ROESCH, Frankfurt (DE); Jasmin JUNGER, Frankfurt (DE)

(21) Appl. No.: 19/111,150

(22) PCT Filed: Aug. 30, 2023
(86) PCT No.: PCT/EP2023/073767

§ 371 Date: Mar. 12, 2025

(30) Foreign Application Priority Data
Sep. 14, 2022 (EP) EP 22195516.4

(51) Int. Cl. C01B 3/384; B01D 53/047; C01B 3/48; C01B 3/56

(52) U.S. Cl. CPC C01B 3/384; B01D 53/047; C01B 3/48; C01B 3/56; B01D 2256/16; B01D 2257/502; B01D 2257/504; B01D 2257/702; C01B 2203/0233; C01B 2203/0283; C01B 2203/042; C01B 2203/047; C01B 2203/0475; C01B 2203/048; C01B 2203/0827; C01B 2203/0883; C01B 2203/1241

(57) ABSTRACT

Provided is a process for producing hydrogen by (a) producing a crude synthesis gas stream in reformer tubes being arranged in a reformer furnace, the interior of which is heated by at least one burner comprising a first fuel gas supply and a second fuel gas supply; (b) cooling the crude synthesis gas stream; (c) producing a hydrogen product stream and a PSA offgas stream from the cooled synthesis gas stream; (d) splitting the PSA offgas stream into a first and second partial PSA offgas stream; (e) separating carbon dioxide from the first partial PSA offgas stream; and (f) introducing a first carbon dioxide depleted partial PSA offgas stream as first fuel gas stream into the first fuel gas supply, and the second partial PSA offgas stream as second fuel gas stream into the second fuel gas supply.

### CROSS-REFERENCE TO RELATED APPLICATIONS

This application is a § 371 of International PCT Application PCT/EP2023/073767, filed Aug. 30, 2023, which claims § 119(a) foreign priority to EP patent application EP 22195516.4, filed Sep. 14, 2022.

### TECHNICAL FIELD

The present disclosure relates generally to reforming process; more specifically, the present disclosure relates to a process and a plant for continuous production of hydrogen by steam reforming of a hydrocarbon-containing feed gas irrespective of an operation mode of a carbon dioxide capture device. The present disclosure also relates to a method for revamping of a hydrogen production plant.

### BACKGROUND

Nowadays hydrogen is seen by many as the most promising future energy vector that would enable reducing amount of carbon dioxide emitted in the atmosphere. However, the large-scale production of hydrogen is still connected to substantial emissions of carbon dioxide. As a result, solutions to produce low-carbon hydrogen are being developed and deployed in the industry, among which capturing the carbon dioxide from a process is one of the most debated.

### RELATED ART

Existing operation of a hydrogen plant with a pre-combustion carbon dioxide capture unit i.e., an amine wash unit upstream of a pressure swing adsorption (PSA) unit, can be challenging with regards to a need to assure continuous production of hydrogen even when the carbon dioxide capture unit is not in operation (e.g., due to a trip). One of the main issues connected to that is handling of PSA tail gas in two scenarios such as with and without the carbon dioxide capture unit. For example, when the carbon dioxide capture unit is in operation, the PSA tail gas will have a smaller flow rate, will be substantially without carbon dioxide and will have a high lower heating value (LHV). Otherwise, when the carbon dioxide capture unit is not in operation, the PSA tail gas will have a higher flow rate, have a high carbon dioxide content and will have a smaller LHV due to inert content. Burning above two very different streams (PSA tail gas) with a same burner (i.e., in steam methane reforming (SMR) fuel side) is an issue due to different fuel properties (Wobbe number), and significant increase in nitrogen oxides (NOx) emissions which also affects plant reliability.

Therefore, there is a need to address aforementioned technical drawbacks in existing known technologies in hydrogen production.

### SUMMARY OF THE INVENTION

The present disclosure seeks to provide an improved approach for continuously producing low-carbon hydrogen, where burning of different streams of pressure swing adsorption (PSA) tail gas, as a result of different operation modes of carbon dioxide capture device, is an issue due to different fuel properties, and significant increase in nitrogen oxides (NOx) emissions which also affects plant reliability. An aim of the present disclosure is to provide a solution that overcomes, at least partially, the problems encountered in prior art and provide a process and a plant for continuously producing hydrogen irrespective of the operation modes of the carbon dioxide capture device such as in full-load operation, partial-load operation and with the carbon dioxide capture device being shut down. The process and the plant use a burner system that comprises at least two fuel gas supplies on a same burner, namely a first fuel gas supply and a second fuel gas supply to cover a high fuel range while minimizing nitrogen oxides (NOx) emissions and ensuring continuous production of hydrogen. The object of the present disclosure is achieved by the solutions provided in the enclosed independent claims. Advantageous implementations of the present disclosure are further defined in the enclosed dependent claims.

According to a first aspect, the present disclosure provides a process for producing hydrogen by steam reforming of a hydrocarbon-containing feed gas, comprising the following steps:
(a) providing a feed gas stream containing gaseous or vaporized hydrocarbons, preferably natural gas or naphtha;
(b) introducing the feed gas stream into a reforming stage, reacting the feed gas stream in the reforming stage under steam reforming conditions in a plurality of reformer tubes filled with a solid particulate reforming catalyst to produce a crude synthesis gas stream containing hydrogen, carbon monoxide, carbon dioxide, and unreacted hydrocarbons, said reformer tubes being arranged in a reformer furnace, the interior of which is heated by means of at least one burner, preferably by a plurality of burners, by combusting at least two fuel gases with oxygen and/or air, said at least one burner or plurality of burners comprising a first fuel gas supply and a second fuel gas supply on the same burner, wherein a first fuel gas is introduced into the first fuel gas supply and a second fuel gas is introduced into the second fuel gas supply; wherein the flow rates of the first fuel gas stream and the second fuel gas stream are adjustable;
(c) discharging the crude synthesis gas stream from the reforming stage and introducing the crude synthesis gas stream into a first cooling device, cooling the crude synthesis gas stream in the first cooling device in indirect heat exchange with at least one coolant stream, discharging a cooled crude synthesis gas stream from the first cooling device;
(d) optionally, introducing at least a part of the cooled crude synthesis gas stream into a CO shift plant comprising at least one CO shift stage, converting the cooled crude synthesis gas stream introduced into the CO shift plant under CO shift conditions to a shifted synthesis gas stream, discharging the shifted synthesis gas stream enriched in hydrogen and carbon dioxide and depleted in carbon monoxide relative to the crude synthesis gas stream;
(e) optionally, introducing the shifted synthesis gas stream into a second cooling device, cooling the shifted synthesis gas stream in the second cooling device in indirect heat exchange with a second coolant stream, discharging a cooled shifted synthesis gas stream from the second cooling device;
(f) introducing the cooled crude synthesis gas stream from step (c) or the cooled shifted synthesis gas stream from optional steps (d) and (e) into a hydrogen enrichment device, operating on the principle of pressure swing adsorption (PSA), discharging a hydrogen product stream and a PSA offgas stream from the hydrogen enrichment device, wherein the PSA offgas stream comprises hydrogen, carbon monoxide, carbon dioxide, and unreacted hydrocarbons;
(g) splitting the PSA offgas stream into a first partial PSA offgas stream and a second partial PSA offgas stream, wherein the first partial PSA offgas stream and the second partial PSA offgas stream both range between and including 0 to 100 mol-% of the PSA offgas stream, and the sum of the first partial PSA offgas stream and the second partial PSA offgas stream equals the PSA offgas stream;
(h) introducing the first partial PSA offgas stream into a carbon dioxide capture device, separating carbon dioxide from the first partial PSA offgas stream under carbon dioxide separation conditions, discharging a first carbon dioxide depleted partial PSA offgas stream and a carbon dioxide enriched offgas stream from the carbon dioxide capture device; and
(i) introducing at least a portion of the first carbon dioxide depleted partial PSA offgas stream as the first fuel gas stream into the first fuel gas supply of the at least one burner or the plurality of burners in the reformer furnace, and introducing at least a portion of the second partial PSA offgas stream as the second fuel gas stream into the second fuel gas supply of the at least one burner or the plurality of burners in the reformer furnace.

According to a second aspect, the present disclosure provides a process for producing hydrogen by steam reforming of a hydrocarbon-containing feed gas, comprising the following steps:
(a) providing a feed gas stream containing gaseous or vaporized hydrocarbons, preferably natural gas or naphtha;
(b) introducing the feed gas stream into a reforming stage, reacting the feed gas stream in the reforming stage under steam reforming conditions in a plurality of reformer tubes filled with a solid particulate reforming catalyst to produce a crude synthesis gas stream containing hydrogen, carbon monoxide, carbon dioxide, and unreacted hydrocarbons, said reformer tubes being arranged in a reformer furnace, the interior of which is heated by means of at least one burner, preferably by a plurality of burners, by combusting at least two fuel gases with oxygen and/or air, said at least one burner or plurality of burners comprising a first fuel gas supply and a second fuel gas supply on the same burner, wherein a first fuel gas is introduced into the first fuel gas supply and a second fuel gas is introduced into the second fuel gas supply; wherein the flow rates of the first fuel gas stream and the second fuel gas stream are adjustable;
(c) discharging the crude synthesis gas stream from the reforming stage and introducing the crude synthesis gas stream into a first cooling device, cooling the crude synthesis gas stream in the first cooling device in indirect heat exchange with at least one coolant stream, discharging a cooled crude synthesis gas stream from the first cooling device;
(d) optionally, introducing at least a part of the cooled crude synthesis gas stream into a CO shift plant comprising at least one CO shift stage, converting the cooled crude synthesis gas stream introduced into the CO shift plant under CO shift conditions to a shifted synthesis gas stream, discharging the shifted synthesis gas stream enriched in hydrogen and carbon dioxide and depleted in carbon monoxide relative to the crude synthesis gas stream;
(e) optionally, introducing the shifted synthesis gas stream into a second cooling device, cooling the shifted synthesis gas stream in the second cooling device in indirect heat exchange with a second coolant stream, discharging a cooled shifted synthesis gas stream from the second cooling device;
(f) introducing the cooled crude synthesis gas stream from step (c) or the cooled shifted synthesis gas stream from optional steps (d) and (e) into a carbon dioxide capture device, separating carbon dioxide from the cooled crude synthesis gas stream or from the cooled shifted synthesis gas stream under carbon dioxide separation conditions, discharging a carbon dioxide depleted synthesis gas stream and a carbon dioxide enriched offgas stream from the carbon dioxide capture device;
(g) introducing the carbon dioxide depleted synthesis gas stream into a hydrogen enrichment device, operating on the principle of pressure swing adsorption (PSA), discharging a hydrogen product stream and a PSA offgas stream from the hydrogen enrichment device, wherein the PSA offgas stream comprises hydrogen, carbon monoxide, carbon dioxide, and unreacted hydrocarbons;
(h) splitting the PSA offgas stream into a first partial PSA offgas stream and a second partial PSA offgas stream, wherein the first partial PSA offgas stream and the second partial PSA offgas stream both range between and including 0 to 100 mol-% of the PSA offgas stream, and the sum of the first partial PSA offgas stream and the second partial PSA offgas stream equals the PSA offgas stream; and
(i) introducing at least a portion of the first partial PSA offgas stream as the first fuel gas stream into the first fuel gas supply of the at least one burner or the plurality of burners in the reformer furnace, and introducing at least a portion of the second partial PSA offgas stream as the second fuel gas stream into the second fuel gas supply of the at least one burner or the plurality of burners in the reformer furnace.

The process for producing the hydrogen according to the present disclosure is of advantage in that the process ensures continuous production of low-carbon hydrogen even when the carbon dioxide capture device is not in operation. The process uses at least two fuel gas supplies on the same burner, namely the first fuel gas supply and the second fuel gas supply, to accommodate different streams of PSA tail gas or PSA offgas while minimizing NOx emissions and ensuring continuous production of hydrogen. When the process is carried out, switching between the first fuel gas supply and the second fuel gas supply is performed in an automatic way without impacting the production of hydrogen. Further, the process increases the overall reliability of a hydrogen production plant and increases a lifetime of the burner system.

According to a third aspect, the present disclosure provides a plant for producing hydrogen by steam reforming of a hydrocarbon-containing feed gas, comprising the following assemblies and components in fluid communication with each other:
(a) means for providing a feed gas stream containing gaseous or vaporized hydrocarbons, preferably natural gas or naphtha;
(b) a reforming stage, comprising a plurality of reformer tubes filled with a solid particulate reforming catalyst to produce a crude synthesis gas stream containing hydrogen, carbon monoxide, carbon dioxide and unreacted hydrocarbons, said reformer tubes being arranged in a reformer furnace, the interior of which is heated by means of at least one burner, preferably by a plurality of burners, by combusting at least two different fuel gases with oxygen and/or air, said at least one burner or plurality of burners comprising a first fuel gas supply and a second fuel gas supply on the same burner, means for introducing a first fuel gas stream into the first fuel gas supply and means for introducing a second fuel gas stream into the second fuel gas supply, means for adjusting the flow rates of the first fuel gas stream and the second fuel gas stream;
means for introducing the feed gas stream into the reforming stage;
means for discharging a crude synthesis gas stream from the reforming stage;
(c) a first cooling device, designed to allow cooling the crude synthesis gas stream in the first cooling device in indirect heat exchange with at least one coolant stream, means for introducing the crude synthesis gas stream into the first cooling device, means for discharging a cooled crude synthesis gas stream from the first cooling device;
(d) optionally, a CO shift plant comprising at least one CO shift stage, means for introducing at least a part of the cooled crude synthesis gas stream into the CO shift plant, means for discharging from the CO shift plant a shifted synthesis gas stream enriched in hydrogen and carbon dioxide and depleted in carbon monoxide relative to the crude synthesis gas stream;
(e) optionally, a second cooling device, designed to allow cooling the shifted synthesis gas stream in the second cooling device in indirect heat exchange with at least one coolant stream, means for introducing the shifted synthesis gas stream into the second cooling device, means for discharging a cooled shifted synthesis gas stream from the second cooling device;
(f) a hydrogen enrichment device, operating on the principle of pressure swing adsorption (PSA), means for introducing the cooled crude synthesis gas stream from step (c) or the cooled shifted synthesis gas stream from optional steps (d) and (e) into the hydrogen enrichment device, means for discharging a hydrogen product stream and a PSA offgas stream from the hydrogen enrichment device, wherein the PSA offgas stream comprises hydrogen, carbon monoxide, carbon dioxide, and unreacted hydrocarbons;
(g) means for splitting the PSA offgas stream into a first partial PSA offgas stream and a second partial PSA offgas stream, means for setting the range of both the first partial PSA offgas stream and the second partial PSA offgas stream between and including 0 to 100 mol-% of the PSA offgas stream, and for setting the sum of the first partial PSA offgas stream and the second partial PSA offgas stream to equal the PSA offgas stream;
(h) a carbon dioxide capture device, designed to allow separating carbon dioxide from the first partial PSA offgas stream under carbon dioxide separation conditions, means for introducing the first partial PSA offgas stream into the carbon dioxide capture device, means for discharging a first carbon dioxide depleted partial PSA offgas stream and a carbon dioxide enriched offgas stream from the carbon dioxide capture device; and
(i) means for introducing at least a portion of the first carbon dioxide depleted partial PSA offgas stream as the first fuel gas stream into the first fuel gas supply of the at least one burner or the plurality of burners in the reformer furnace, and means for introducing at least a portion of the second partial PSA offgas stream as the second fuel gas stream into the second fuel gas supply of the at least one burner or the plurality of burners in the reformer furnace. According to a fourth aspect, the present disclosure provides a plant for producing hydrogen by steam reforming of a hydrocarbon-containing feed gas, comprising the following assemblies and components in fluid communication with each other:
(a) means for providing a feed gas stream containing gaseous or vaporized hydrocarbons, preferably natural gas or naphtha;
(b) a reforming stage, comprising a plurality of reformer tubes filled with a solid particulate reforming catalyst to produce a crude synthesis gas stream containing hydrogen, carbon monoxide, carbon dioxide and unreacted hydrocarbons, said reformer tubes being arranged in a reformer furnace, the interior of which is heated by means of at least one burner, preferably by a plurality of burners, by combusting at least two different fuel gases with oxygen and/or air, said at least one burner or plurality of burners comprising a first fuel gas supply and a second fuel gas supply on the same burner, means for introducing a first fuel gas stream into the first fuel gas supply and means for introducing a second fuel gas stream into the second fuel gas supply, means for adjusting the flow rates of the first fuel gas stream and the second fuel gas stream;
means for introducing the feed gas stream into the reforming stage;
means for discharging a crude synthesis gas stream from the reforming stage;
(c) a first cooling device, designed to allow cooling the crude synthesis gas stream in the first cooling device in indirect heat exchange with at least one coolant stream, means for introducing the crude synthesis gas stream into the first cooling device, means for discharging a cooled crude synthesis gas stream from the first cooling device;
(d) optionally, a CO shift plant comprising at least one CO shift stage, means for introducing at least a part of the cooled crude synthesis gas stream into the CO shift plant, means for discharging from the CO shift plant a shifted synthesis gas stream enriched in hydrogen and carbon dioxide and depleted in carbon monoxide relative to the crude synthesis gas stream;
(e) optionally, a second cooling device, designed to allow cooling the shifted synthesis gas stream in the second cooling device in indirect heat exchange with at least one coolant stream, means for introducing the shifted synthesis gas stream into the second cooling device, means for discharging a cooled shifted synthesis gas stream from the second cooling device;
(f) a carbon dioxide capture device, designed to allow separating carbon dioxide from the cooled shifted synthesis gas stream under carbon dioxide separation conditions, means for introducing the cooled crude synthesis gas stream from step (c) or the cooled shifted synthesis gas stream from optional steps (d) and (e) into the carbon dioxide capture device, means for discharging a carbon dioxide depleted synthesis gas stream and a carbon dioxide offgas stream from the carbon dioxide capture device;
(g) a hydrogen enrichment device, operating on the principle of pressure swing adsorption (PSA), means for introducing the carbon dioxide depleted synthesis gas stream into the hydrogen enrichment device, means for discharging a hydrogen product stream and a PSA offgas stream from the hydrogen enrichment device, wherein the PSA offgas stream comprises hydrogen, carbon monoxide, carbon dioxide, and unreacted hydrocarbons;
(h) means for splitting the PSA offgas stream into a first partial PSA offgas stream and a second partial PSA offgas stream, means for setting the range of both the first partial PSA offgas stream and the second partial PSA offgas stream between and including 0 to 100 mol-% of the PSA offgas stream, and for setting the sum of the first partial PSA offgas stream and the second partial PSA offgas stream to equal the PSA offgas stream; and
(i) means for introducing at least a portion of the first partial PSA offgas stream as the first fuel gas stream into the first fuel gas supply of the at least one burner or the plurality of burners in the reformer furnace, and means for introducing at least a portion of the second partial PSA offgas stream as the second fuel gas stream into the second fuel gas supply of the at least one burner or the plurality of burners in the reformer furnace.

The plant for producing the hydrogen according to the present disclosure is of advantage in that the plant ensures continuous production of low-carbon hydrogen even when the carbon dioxide capture device is not in operation. The plant uses at least two fuel gas supplies on the same burner, namely the first fuel gas supply and the second fuel gas supply, to accommodate different streams of PSA tail gas or PSA offgas which are due to different operation modes of the carbon dioxide capture device such as in full-load operation, partial-load operation and with the carbon dioxide capture device being shut down. Accordingly, the plant ensures continuous production of hydrogen minimizes NOx emissions and increases a lifetime of the burner system. When the plant is in operation, switching between the first fuel gas supply and the second fuel gas supply is performed in an automatic way without impacting the production of hydrogen.

According to a fifth aspect, the present disclosure provides a method for revamping of a hydrogen production plant, wherein the hydrogen production plant comprises the following assemblies and components in fluid communication with each other:
(a) means for providing a feed gas stream containing gaseous or vaporized hydrocarbons, preferably natural gas or naphtha;
(b) a reforming stage, comprising a plurality of reformer tubes filled with a solid particulate reforming catalyst to produce a crude synthesis gas stream containing hydrogen, carbon monoxide, carbon dioxide and unreacted hydrocarbons, said reformer tubes being arranged in a reformer furnace, the interior of which is heated by means of at least one burner, preferably by a plurality of burners, by combusting at least two different fuel gases with oxygen and/or air, said at least one burner or plurality of burners comprising a first fuel gas supply and a second fuel gas supply on the same burner, means for introducing a first fuel gas stream into the first fuel gas supply and means for introducing a second fuel gas stream into the second fuel gas supply, means for adjusting the flow rates of the first fuel gas stream and the second fuel gas stream;
means for introducing the feed gas stream into the reforming stage;
means for discharging a crude synthesis gas stream from the reforming stage;
(c) a first cooling device, designed to allow cooling the crude synthesis gas stream in the first cooling device in indirect heat exchange with at least one coolant stream, means for introducing the crude synthesis gas stream into the first cooling device, means for discharging a cooled crude synthesis gas stream from the first cooling device;
(d) optionally, a CO shift plant comprising at least one CO shift stage, means for introducing at least a part of the cooled crude synthesis gas stream into the CO shift plant, means for discharging from the CO shift plant a shifted synthesis gas stream enriched in hydrogen and carbon dioxide and depleted in carbon monoxide relative to the crude synthesis gas stream;
(e) optionally, a second cooling device, designed to allow cooling the shifted synthesis gas stream in the second cooling device in indirect heat exchange with at least one coolant stream, means for introducing the shifted synthesis gas stream into the second cooling device, means for discharging a cooled shifted synthesis gas stream from the second cooling device; and
(f) a hydrogen enrichment device, operating on the principle of pressure swing adsorption (PSA), means for introducing the cooled crude synthesis gas stream from step (c) or the cooled shifted synthesis gas stream from optional steps (d) and (e) into the hydrogen enrichment device, means for discharging a hydrogen product stream and a PSA offgas stream from the hydrogen enrichment device, wherein the PSA offgas stream comprises hydrogen, carbon monoxide, carbon dioxide, and unreacted hydrocarbons;
   said method for revamping comprising the steps of:
(g) installing means for splitting the PSA offgas stream into a first partial PSA offgas stream and a second partial PSA offgas stream, installing means for setting the range of both the first partial PSA offgas stream and the second partial PSA offgas stream between and including 0 to 100 mol-% of the PSA offgas stream, and for setting the sum of the first partial PSA offgas stream and the second partial PSA offgas stream to equal the PSA offgas stream;
(h) installing a carbon dioxide capture device, designed to allow separating carbon dioxide from the first partial PSA offgas stream under carbon dioxide separation conditions, installing means for introducing the first partial PSA offgas stream into the carbon dioxide capture device, installing means for discharging a first carbon dioxide depleted partial PSA offgas stream and a carbon dioxide enriched offgas stream from the carbon dioxide capture device; and
(i) installing means for introducing at least a portion of the first carbon dioxide depleted partial PSA offgas stream as the first fuel gas stream into the first fuel gas supply of the at least one burner or the plurality of burners in the reformer furnace, and installing means for introducing at least a portion of the second partial PSA offgas stream as the second fuel gas stream into the second fuel gas supply of the at least one burner or the plurality of burners in the reformer furnace.

According to a sixth aspect, the present disclosure provides a method for revamping of a hydrogen production plant, wherein the hydrogen production plant comprises the following assemblies and components in fluid communication with each other:
(a) means for providing a feed gas stream containing gaseous or vaporized hydrocarbons, preferably natural gas or naphtha;
(b) a reforming stage, comprising a plurality of reformer tubes filled with a solid particulate reforming catalyst to produce a crude synthesis gas stream containing hydrogen, carbon monoxide, carbon dioxide and unreacted hydrocarbons, said reformer tubes being arranged in a reformer furnace, the interior of which is heated by means of at least one burner, preferably by a plurality of burners, by combusting at least two different fuel gases with oxygen and/or air, said at least one burner or plurality of burners comprising a first fuel gas supply and a second fuel gas supply on the same burner, means for introducing a first fuel gas stream into the first fuel gas supply and means for introducing a second fuel gas stream into the second fuel gas supply, means for adjusting the flow rates of the first fuel gas stream and the second fuel gas stream;
means for introducing the feed gas stream into the reforming stage;
means for discharging a crude synthesis gas stream from the reforming stage;
(c) a first cooling device, designed to allow cooling the crude synthesis gas stream in the first cooling device in indirect heat exchange with at least one coolant stream, means for introducing the crude synthesis gas stream into the first cooling device, means for discharging a cooled crude synthesis gas stream from the first cooling device;
(d) optionally, a CO shift plant comprising at least one CO shift stage, means for introducing at least a part of the cooled crude synthesis gas stream into the CO shift plant, means for discharging from the CO shift plant a shifted synthesis gas stream enriched in hydrogen and carbon dioxide and depleted in carbon monoxide relative to the crude synthesis gas stream;
(e) optionally, a second cooling device, designed to allow cooling the shifted synthesis gas stream in the second cooling device in indirect heat exchange with at least one coolant stream, means for introducing the shifted synthesis gas stream into the second cooling device, means for discharging a cooled shifted synthesis gas stream from the second cooling device; and
(f) a hydrogen enrichment device, operating on the principle of pressure swing adsorption (PSA), means for introducing the carbon dioxide depleted synthesis gas stream into the hydrogen enrichment device, means for discharging a hydrogen product stream and a PSA offgas stream from the hydrogen enrichment device, wherein the PSA offgas stream comprises hydrogen, carbon monoxide, carbon dioxide, and unreacted hydrocarbons; said method for revamping comprising the steps of:
(g) installing a carbon dioxide capture device, designed to allow separating carbon dioxide from the cooled shifted synthesis gas stream under carbon dioxide separation conditions, installing means for introducing the cooled crude synthesis gas stream from step (c) or the cooled shifted synthesis gas stream from optional steps (d) and (e) into the carbon dioxide capture device, installing means for discharging a carbon dioxide depleted synthesis gas stream and a carbon dioxide offgas stream from the carbon dioxide capture device;
(h) installing means for splitting the PSA offgas stream into a first partial PSA offgas stream and a second partial PSA offgas stream, installing means for setting the range of both the first partial PSA offgas stream and the second partial PSA offgas stream between and including 0 to 100 mol-% of the PSA offgas stream, and for setting the sum of the first partial PSA offgas stream and the second partial PSA offgas stream to equal the PSA offgas stream; and
(i) installing means for introducing at least a portion of the first partial PSA offgas stream as the first fuel gas stream into the first fuel gas supply of the at least one burner or the plurality of burners in the reformer furnace, and installing means for introducing at least a portion of the second partial PSA offgas stream as the second fuel gas stream into the second fuel gas supply of the at least one burner or the plurality of burners in the reformer furnace.

The method for revamping of the hydrogen production plant according to the present disclosure is of advantage in that the method enables to convert an existing hydrogen production plant in order to produce low-carbon hydrogen continuously even when the carbon dioxide capture device is not in operation.

Embodiments of the present disclosure eliminate the aforementioned drawbacks in existing known approaches using the burner system with at least two fuel gas supply to accommodate different streams of PSA offgas, thereby enabling continuous production of low-carbon hydrogen even when the carbon dioxide capture device is not in operation and also minimizing NOx emissions.

Additional aspects, advantages, features and objects of the present disclosure are made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. To illustrate the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, the same elements have been indicated by identical numbers.

Embodiments of the present disclosure will now be described, by way of example only, with reference to the following diagrams wherein:

FIG. 1 is a block diagram of a plant for producing hydrogen by steam reforming of a hydrocarbon-containing feed gas where a carbon dioxide capture device is downstream to a hydrogen enrichment device according to an embodiment of the present disclosure;

FIG. 2 is a block diagram of a plant for producing hydrogen by steam reforming of a hydrocarbon-containing feed gas where a carbon dioxide capture device is upstream to a hydrogen enrichment device according to an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

As used herein, several terms are defined below:

$$Wobbe Index ( IW ) = HHV / √ ( SG ) ,$$

where:

HHV is the higher heating value.

SG is the specific gravity of the gas defined at standard conditions STD (0° C. and 1 atm).

Further, SG can be expressed as:

$$SG = density of the gas ( at STD conditions ) / density of air ( at STD conditions ) = molar mass of the gas / molar mass of air .$$

√(SG) is the square root of the specific gravity of the gas.

The term “feed gas stream” is to be understood as meaning a feedstock or a raw material used to produce a synthesis gas product.

Steam reforming is a most common process used to produce the synthesis gas product. The reaction is represented by this equilibrium:

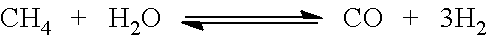

Steam reforming conditions and carbon monoxide (CO) shift conversion conditions are known to those skilled in the art from the prior art. These are the physicochemical conditions under which a measurable, preferably industrially relevant, conversion of hydrocarbons to synthesis gas products is achieved. For example, in the context of steam reforming, important parameters include adjustment of a suitable steam reforming entry temperature of typically about 1000° C. and addition of steam to the input gas containing hydrocarbons and thus adjustment of a steam/carbon ratio (S/C ratio). Typical values for the S/C ratio are between 1.5 and 3.5 mol/mol. Typical steam reforming inlet temperatures are up to 700° C. and typically range between 550° C. and 650° C. Necessary adjustments of these conditions to the respective operational requirements will be made by those skilled in the art on the basis of routine experiments. Any specific reaction conditions disclosed may serve here as a guide, but they should not be regarded as limiting in relation to the scope of the invention.

Pressures, if any, are reported in absolute pressure units, bara for short, or in gauge pressure units, barg for short, unless otherwise stated in the particular individual context.

A fluid connection between two regions of the apparatus or plant according to the invention is to be understood as meaning any type of connection whatsoever which makes it possible for a fluid, for example a gas stream, to flow from one to the other of the two regions, neglecting any interposed regions or components. In particular a direct fluid connection is to be understood as meaning any type of connection whatsoever which makes it possible for a fluid, for example a gas stream, to flow directly from one to the other of the two regions, wherein no further regions or components are interposed with the exception of purely transportational operations and the means required therefor, for example pipelines, valves, pumps, compressors, reservoirs. One example would be a pipeline leading directly from one to the other of the two regions.

A means is to be understood as meaning something that enables or is helpful in the achievement of a goal. In particular, means for performing a particular process step are to be understood as meaning any physical articles that would be considered by a person skilled in the art in order to be able to perform this process step. For example, a person skilled in the art will consider means of introducing or discharging a material stream to include any transporting and conveying apparatuses, i.e., for example pipelines, pumps, compressors, valves, which seem necessary or sensible to said skilled person for performance of this process step on the basis of his knowledge of the art.

For the purposes of this description steam is to be understood as being synonymous with water vapor unless the opposite is indicated in an individual case. By contrast, the term “water” refers to water in the liquid state of matter unless otherwise stated in an individual case.

In the context of the present disclosure, carbon dioxide separation conditions refer to the specific conditions of a selected physical or chemical carbon dioxide separation process which are known to a skilled person. A physical or chemical carbon dioxide separation process is understood to be a process that enables a fluid mixture, for example a gas mixture, to be separated into its components or undesirable components to be separated from this mixture by applying suitable physicochemical conditions, for example by phase transition such as condensation or by using a suitable sorbent. When a sorption process is used, it may be based on adsorption, i.e., binding of the substance or substances to be separated to a surface or interface of the solid adsorbent, or on absorption, i.e., uptake of the substance or substances to be separated into the volume of the liquid or solid adsorbent. The substance or substances separated and bound by means of sorption are referred to as adsorbate or absorbate. The binding forces acting in this process can be of a physical or chemical nature. Accordingly, weaker, non-specific binding forces, e.g., van der Waals forces, usually act in physical sorption, whereas stronger, more specific binding forces act in chemical sorption and the adsorbate and/or absorbent is chemically changed.

As synonyms for the term absorbent, the terms solvent or washing agent in the case of liquid absorbents are used in the context of the present disclosure.

A specific, physical absorption process is the gas scrubbing with cryogenic methanol, which uses methanol as absorbent or scrubbing agent, the temperature of which has been cooled by means of cold-generating processes below ambient temperature, preferably below 0° C., most preferably below −30° C. This process is known to the skilled person as the Rectisol process.

In contrast, the amine washes, which are known per se and frequently used for the absorption of carbon dioxide, are based on chemical absorption (chemisorption) and achieve high purities even at relatively low pressures in the absorption column. The selectivity is also usually higher than with physical absorption processes.

In amine washing, slightly alkaline aqueous solutions of amines, often ethanolamine derivatives, are used in an absorption unit (absorption section) usually designed as a washing column. Absorption takes place at low temperature, e.g., 40° C., and slightly elevated pressure, e.g., 8 bara. Fresh or regenerated absorbent is fed at the top of the column and the gas stream to be separated is introduced in the lower section of the scrubbing column. In this process, carbon dioxide is reversibly chemically absorbed. The gas, which is depleted in carbon dioxide, leaves the column at the top and the loaded scrubbing agent is discharged at the bottom of the column and fed into a desorption section, which is also frequently designed as a separation column. In the desorption column (regeneration section), the reaction reverses the chemical equilibrium at a higher temperature and lower pressure, thus releasing the absorbed carbon dioxide as a gas. It can then be discharged at the head of the desorption column for further use or disposal. The absorbent regenerated in this way is returned to the absorption section.

An absorbent commonly used in amine scrubbing is methyldiethanolamine (MDEA), which is mostly used in aqueous solutions. In addition, activators, for example piperazine, are often added to accelerate carbon dioxide absorption, as described, for example, in the article “The Activator Mechanism of Piperazine in Aqueous Methyldiethanolamine Solutions,” J. Ying et al, Energy Procedia 114 (2017), pp. 2078-2087. These mixtures are then referred to as activated MDEA solutions (aMDEA).

Optional or optionally means that the subsequently described event or circumstances may or may not occur. The description includes instances where the event or circumstance occurs and instances where it does not occur.

“Providing” in a claim is defined to mean furnishing, supplying, making available, or preparing something. The step may be performed by any actor in the absence of express language in the claim to the contrary.

According to a first aspect, the present disclosure provides a process for producing hydrogen by steam reforming of a hydrocarbon-containing feed gas, comprising the following steps:
(a) providing a feed gas stream containing gaseous or vaporized hydrocarbons, preferably natural gas or naphtha;
(b) introducing the feed gas stream into a reforming stage, reacting the feed gas stream in the reforming stage under steam reforming conditions in a plurality of reformer tubes filled with a solid particulate reforming catalyst to produce a crude synthesis gas stream containing hydrogen, carbon monoxide, carbon dioxide, and unreacted hydrocarbons, said reformer tubes being arranged in a reformer furnace, the interior of which is heated by means of at least one burner, preferably by a plurality of burners, by combusting at least two fuel gases with oxygen and/or air, said at least one burner or plurality of burners comprising a first fuel gas supply and a second fuel gas supply on the same burner, wherein a first fuel gas is introduced into the first fuel gas supply and a second fuel gas is introduced into the second fuel gas supply; wherein the flow rates of the first fuel gas stream and the second fuel gas stream are adjustable;
(c) discharging the crude synthesis gas stream from the reforming stage and introducing the crude synthesis gas stream into a first cooling device, cooling the crude synthesis gas stream in the first cooling device in indirect heat exchange with at least one coolant stream, discharging a cooled crude synthesis gas stream from the first cooling device;
(d) optionally, introducing at least a part of the cooled crude synthesis gas stream into a CO shift plant comprising at least one CO shift stage, converting the cooled crude synthesis gas stream introduced into the CO shift plant under CO shift conditions to a shifted synthesis gas stream, discharging the shifted synthesis gas stream enriched in hydrogen and carbon dioxide and depleted in carbon monoxide relative to the crude synthesis gas stream;
(e) optionally, introducing the shifted synthesis gas stream into a second cooling device, cooling the shifted synthesis gas stream in the second cooling device in indirect heat exchange with a second coolant stream, discharging a cooled shifted synthesis gas stream from the second cooling device;
(f) introducing the cooled crude synthesis gas stream from step (c) or the cooled shifted synthesis gas stream from optional steps (d) and (e) into a hydrogen enrichment device, operating on the principle of pressure swing adsorption (PSA), discharging a hydrogen product stream and a PSA offgas stream from the hydrogen enrichment device, wherein the PSA offgas stream comprises hydrogen, carbon monoxide, carbon dioxide, and unreacted hydrocarbons;
(g) splitting the PSA offgas stream into a first partial PSA offgas stream and a second partial PSA offgas stream, wherein the first partial PSA offgas stream and the second partial PSA offgas stream both range between and including 0 to 100 mol-% of the PSA offgas stream, and the sum of the first partial PSA offgas stream and the second partial PSA offgas stream equals the PSA offgas stream;
(h) introducing the first partial PSA offgas stream into a carbon dioxide capture device, separating carbon dioxide from the first partial PSA offgas stream under carbon dioxide separation conditions, discharging a first carbon dioxide depleted partial PSA offgas stream and a carbon dioxide enriched offgas stream from the carbon dioxide capture device; and (i) introducing at least a portion of the first carbon dioxide depleted partial PSA offgas stream as the first fuel gas stream into the first fuel gas supply of the at least one burner or the plurality of burners in the reformer furnace, and introducing at least a portion of the second partial PSA offgas stream as the second fuel gas stream into the second fuel gas supply of the at least one burner or the plurality of burners in the reformer furnace.

According to a second aspect, the present disclosure provides a process for producing hydrogen by steam reforming of a hydrocarbon-containing feed gas, comprising the following steps:
(a) providing a feed gas stream containing gaseous or vaporized hydrocarbons, preferably natural gas or naphtha;
(b) introducing the feed gas stream into a reforming stage, reacting the feed gas stream in the reforming stage under steam reforming conditions in a plurality of reformer tubes filled with a solid particulate reforming catalyst to produce a crude synthesis gas stream containing hydrogen, carbon monoxide, carbon dioxide, and unreacted hydrocarbons, said reformer tubes being arranged in a reformer furnace, the interior of which is heated by means of at least one burner, preferably by a plurality of burners, by combusting at least two fuel gases with oxygen and/or air, said at least one burner or plurality of burners comprising a first fuel gas supply and a second fuel gas supply on the same burner, wherein a first fuel gas is introduced into the first fuel gas supply and a second fuel gas is introduced into the second fuel gas supply; wherein the flow rates of the first fuel gas stream and the second fuel gas stream are adjustable;
(c) discharging the crude synthesis gas stream from the reforming stage and introducing the crude synthesis gas stream into a first cooling device, cooling the crude synthesis gas stream in the first cooling device in indirect heat exchange with at least one coolant stream, discharging a cooled crude synthesis gas stream from the first cooling device;
(d) optionally, introducing at least a part of the cooled crude synthesis gas stream into a CO shift plant comprising at least one CO shift stage, converting the cooled crude synthesis gas stream introduced into the CO shift plant under CO shift conditions to a shifted synthesis gas stream, discharging the shifted synthesis gas stream enriched in hydrogen and carbon dioxide and depleted in carbon monoxide relative to the crude synthesis gas stream;
(e) optionally, introducing the shifted synthesis gas stream into a second cooling device, cooling the shifted synthesis gas stream in the second cooling device in indirect heat exchange with a second coolant stream, discharging a cooled shifted synthesis gas stream from the second cooling device;
(f) introducing the cooled crude synthesis gas stream from step (c) or the cooled shifted synthesis gas stream from optional steps (d) and (e) into a carbon dioxide capture device, separating carbon dioxide from the cooled crude synthesis gas stream or from the cooled shifted synthesis gas stream under carbon dioxide separation conditions, discharging a carbon dioxide depleted synthesis gas stream and a carbon dioxide enriched offgas stream from the carbon dioxide capture device;
(g) introducing the carbon dioxide depleted synthesis gas stream into a hydrogen enrichment device, operating on the principle of pressure swing adsorption (PSA), discharging a hydrogen product stream and a PSA offgas stream from the hydrogen enrichment device, wherein the PSA offgas stream comprises hydrogen, carbon monoxide, carbon dioxide, and unreacted hydrocarbons;
(h) splitting the PSA offgas stream into a first partial PSA offgas stream and a second partial PSA offgas stream, wherein the first partial PSA offgas stream and the second partial PSA offgas stream both range between and including 0 to 100 mol-% of the PSA offgas stream, and the sum of the first partial PSA offgas stream and the second partial PSA offgas stream equals the PSA offgas stream; and
(i) introducing at least a portion of the first partial PSA offgas stream as the first fuel gas stream into the first fuel gas supply of the at least one burner or the plurality of burners in the reformer furnace, and introducing at least a portion of the second partial PSA offgas stream as the second fuel gas stream into the second fuel gas supply of the at least one burner or the plurality of burners in the reformer furnace.

The process for producing the hydrogen according to the present disclosure is of advantage in that the process ensures continuous production of low-carbon hydrogen even when the carbon dioxide capture device is not in operation. The process uses at least two fuel gas supplies on the same burner, namely the first fuel gas supply and the second fuel gas supply, to accommodate different streams of PSA tail gas or PSA offgas while minimizing NOx emissions and ensuring continuous production of hydrogen. When the process is carried out, switching between the first fuel gas supply and the second fuel gas supply is performed in an automatic way without impacting the production of hydrogen. Further, the process increases the overall reliability of a hydrogen production plant and increases a lifetime of the burner system.

Optionally, the carbon dioxide capture device is an amine wash unit. Optionally, the first fuel gas supply is a small burner header which is the only one used when the carbon dioxide capture device is in operation. The first fuel gas supply may be connected to staged burner tips while the second fuel gas supply connected to a primary burner tip.

Optionally, the carbon dioxide capture device can be bypassed completely or partially.

In one example, the first fuel gas supply is always in operation to its maximum extent, while the second fuel gas supply starts receiving flow when the carbon dioxide capture device is bypassed to a certain extent.

Optionally, the first fuel gas supply of the at least one burner or the plurality of burners is configured to permit operation with a fuel gas having a low flow rate, a low carbon dioxide concentration and a high lower heating value, and in that the second fuel gas supply of the at least one burner or the plurality of burners is configured to permit operation with a fuel gas having a high flow rate, a high carbon dioxide concentration and a low lower heating value.

Optionally, the first fuel gas supply of the at least one burner is configured to permit operation of the at least one burner or the plurality of burners with a fuel gas having a first Wobbe index (IW1), and in that the second fuel gas supply of the at least one burner is configured to permit operation of the at least one burner or the plurality of burners with a fuel gas having a second Wobbe index (IW2), and in that a ratio r between the two Wobbe indices (r=IW1/IW2) is larger than 1.8, preferably between 3 and 7, more preferably between 4.5 and 5.5.

Optionally, when the process is carried out with the carbon dioxide capture device in full-load operation, the entire first fuel gas stream is introduced into the first fuel gas supply, whereas only a part of the second fuel gas stream is introduced into the second fuel gas supply, corresponding to a fraction of less than 1 of its full flow or to zero. Accordingly, the overall reliability of the hydrogen plant and the lifetime of the burner is increased.

Optionally, when the process is carried out with the carbon dioxide capture device in partial-load operation or with the carbon dioxide capture device being shut down, the entire second fuel gas stream is introduced into the second fuel gas supply, whereas only a part of the first fuel gas stream is introduced into the first fuel gas supply, corresponding to a fraction of less than 1 of its full flow or to zero. Accordingly, the fuel throughput is increased while minimizing the burner tip pressure drop and enabling nominal heat release.

When the carbon dioxide capture device is upstream to the hydrogen enrichment device, both the first fuel gas supply and the second fuel gas supply may receive same PSA offgas stream composition. In such scenario, the process may enable an automatic flow control system to divert a desired flow to each of the fuel gas supply.

Optionally, a flow diversion between the first fuel gas supply and the second fuel gas supply is controlled to allow as much as fuel to the first fuel gas supply as it is acceptable due to pressure drop limitations or opening or closing the connection to the second fuel gas supply via an automatic on or off valve in which case PSA offgas stream flow distribution determined by the restriction in the totality of burner tips of the first fuel gas supply versus second fuel gas supply.

Optionally, a third fuel gas containing hydrocarbons is additionally supplied to the at least one burner or the plurality of burners and combusted with oxygen and/or air. This allows for a better stability of the burner operation, for example during transient operations like plant startups or shut downs. At the same time, the energy input produced by the burners can be increased.

Optionally, the third fuel gas is supplied to the at least one burner or the plurality of burners via the first fuel gas supply and/or the second fuel gas supply and/or a third fuel gas supply, preferably arranged on the same at least one burner or the same plurality of burners. This allows for greater flexibility for introducing the third fuel gas, thus avoiding, or voluntarily producing, heat gradients in the reformer furnace.

Optionally, the first fuel gas supply is used as a common fuel gas supply for all fuel gases while the second fuel gas supply is used for operating with the fuel gas having a high flow rate, high carbon dioxide concentration and low lower heating value.

Optionally, the flue gas from the plant is recycled at least partially, for example recycled to the reformer furnace, thereby improving the operability of the plant and the burner system with flexible carbon dioxide capture scenarios.

According to a third aspect, the present disclosure provides a plant for producing hydrogen by steam reforming of a hydrocarbon-containing feed gas, comprising the following assemblies and components in fluid communication with each other:
(a) means for providing a feed gas stream containing gaseous or vaporized hydrocarbons, preferably natural gas or naphtha;
(b) a reforming stage, comprising a plurality of reformer tubes filled with a solid particulate reforming catalyst to produce a crude synthesis gas stream containing hydrogen, carbon monoxide, carbon dioxide and unreacted hydrocarbons, said reformer tubes being arranged in a reformer furnace, the interior of which is heated by means of at least one burner, preferably by a plurality of burners, by combusting at least two different fuel gases with oxygen and/or air, said at least one burner or plurality of burners comprising a first fuel gas supply and a second fuel gas supply on the same burner, means for introducing a first fuel gas stream into the first fuel gas supply and means for introducing a second fuel gas stream into the second fuel gas supply, means for adjusting the flow rates of the first fuel gas stream and the second fuel gas stream;
means for introducing the feed gas stream into the reforming stage;
means for discharging a crude synthesis gas stream from the reforming stage;
(c) a first cooling device, designed to allow cooling the crude synthesis gas stream in the first cooling device in indirect heat exchange with at least one coolant stream, means for introducing the crude synthesis gas stream into the first cooling device, means for discharging a cooled crude synthesis gas stream from the first cooling device;
(d) optionally, a CO shift plant comprising at least one CO shift stage, means for introducing at least a part of the cooled crude synthesis gas stream into the CO shift plant, means for discharging from the CO shift plant a shifted synthesis gas stream enriched in hydrogen and carbon dioxide and depleted in carbon monoxide relative to the crude synthesis gas stream;
(e) optionally, a second cooling device, designed to allow cooling the shifted synthesis gas stream in the second cooling device in indirect heat exchange with at least one coolant stream, means for introducing the shifted synthesis gas stream into the second cooling device, means for discharging a cooled shifted synthesis gas stream from the second cooling device;
(f) a hydrogen enrichment device, operating on the principle of pressure swing adsorption (PSA), means for introducing the cooled crude synthesis gas stream from step (c) or the cooled shifted synthesis gas stream from optional steps (d) and (e) into the hydrogen enrichment device, means for discharging a hydrogen product stream and a PSA offgas stream from the hydrogen enrichment device, wherein the PSA offgas stream comprises hydrogen, carbon monoxide, carbon dioxide, and unreacted hydrocarbons;
(g) means for splitting the PSA offgas stream into a first partial PSA offgas stream and a second partial PSA offgas stream, means for setting the range of both the first partial PSA offgas stream and the second partial PSA offgas stream between and including 0 to 100 mol-% of the PSA offgas stream, and for setting the sum of the first partial PSA offgas stream and the second partial PSA offgas stream to equal the PSA offgas stream;
(h) a carbon dioxide capture device, designed to allow separating carbon dioxide from the first partial PSA offgas stream under carbon dioxide separation conditions, means for introducing the first partial PSA offgas stream into the carbon dioxide capture device, means for discharging a first carbon dioxide depleted partial PSA offgas stream and a carbon dioxide enriched offgas stream from the carbon dioxide capture device; and
(i) means for introducing at least a portion of the first carbon dioxide depleted partial PSA offgas stream as the first fuel gas stream into the first fuel gas supply of the at least one burner or the plurality of burners in the reformer furnace, and means for introducing at least a portion of the second partial PSA offgas stream as the second fuel gas stream into the second fuel gas supply of the at least one burner or the plurality of burners in the reformer furnace.

According to a fourth aspect, the present disclosure provides a plant for producing hydrogen by steam reforming of a hydrocarbon-containing feed gas, comprising the following assemblies and components in fluid communication with each other:
(a) means for providing a feed gas stream containing gaseous or vaporized hydrocarbons, preferably natural gas or naphtha;
(b) a reforming stage, comprising a plurality of reformer tubes filled with a solid particulate reforming catalyst to produce a crude synthesis gas stream containing hydrogen, carbon monoxide, carbon dioxide and unreacted hydrocarbons, said reformer tubes being arranged in a reformer furnace, the interior of which is heated by means of at least one burner, preferably by a plurality of burners, by combusting at least two different fuel gases with oxygen and/or air, said at least one burner or plurality of burners comprising a first fuel gas supply and a second fuel gas supply on the same burner, means for introducing a first fuel gas stream into the first fuel gas supply and means for introducing a second fuel gas stream into the second fuel gas supply, means for adjusting the flow rates of the first fuel gas stream and the second fuel gas stream;
means for introducing the feed gas stream into the reforming stage;
means for discharging a crude synthesis gas stream from the reforming stage;
(c) a first cooling device, designed to allow cooling the crude synthesis gas stream in the first cooling device in indirect heat exchange with at least one coolant stream, means for introducing the crude synthesis gas stream into the first cooling device, means for discharging a cooled crude synthesis gas stream from the first cooling device;
(d) optionally, a CO shift plant comprising at least one CO shift stage, means for introducing at least a part of the cooled crude synthesis gas stream into the CO shift plant, means for discharging from the CO shift plant a shifted synthesis gas stream enriched in hydrogen and carbon dioxide and depleted in carbon monoxide relative to the crude synthesis gas stream;
(e) optionally, a second cooling device, designed to allow cooling the shifted synthesis gas stream in the second cooling device in indirect heat exchange with at least one coolant stream, means for introducing the shifted synthesis gas stream into the second cooling device, means for discharging a cooled shifted synthesis gas stream from the second cooling device;
(f) a carbon dioxide capture device, designed to allow separating carbon dioxide from the cooled shifted synthesis gas stream under carbon dioxide separation conditions, means for introducing the cooled crude synthesis gas stream from step (c) or the cooled shifted synthesis gas stream from optional steps (d) and (e) into the carbon dioxide capture device, means for discharging a carbon dioxide depleted synthesis gas stream and a carbon dioxide offgas stream from the carbon dioxide capture device;
(g) a hydrogen enrichment device, operating on the principle of pressure swing adsorption (PSA), means for introducing the carbon dioxide depleted synthesis gas stream into the hydrogen enrichment device, means for discharging a hydrogen product stream and a PSA offgas stream from the hydrogen enrichment device, wherein the PSA offgas stream comprises hydrogen, carbon monoxide, carbon dioxide, and unreacted hydrocarbons;
(h) means for splitting the PSA offgas stream into a first partial PSA offgas stream and a second partial PSA offgas stream, means for setting the range of both the first partial PSA offgas stream and the second partial PSA offgas stream between and including 0 to 100 mol-% of the PSA offgas stream, and for setting the sum of the first partial PSA offgas stream and the second partial PSA offgas stream to equal the PSA offgas stream; and
(i) means for introducing at least a portion of the first partial PSA offgas stream as the first fuel gas stream into the first fuel gas supply of the at least one burner or the plurality of burners in the reformer furnace, and means for introducing at least a portion of the second partial PSA offgas stream as the second fuel gas stream into the second fuel gas supply of the at least one burner or the plurality of burners in the reformer furnace.

The plant for producing the hydrogen according to the present disclosure is of advantage in that the plant ensures continuous production of low-carbon hydrogen even when the carbon dioxide capture device is not in operation. The plant uses at least two fuel gas supplies on the same burner, namely the first fuel gas supply and the second fuel gas supply, to accommodate different streams of PSA tail gas or PSA offgas which are due to different operation modes of the carbon dioxide capture device such as in full-load operation, partial-load operation and with the carbon dioxide capture device being shut down. Accordingly, the plant ensures continuous production of hydrogen minimizes NOx emissions and increases a lifetime of the burner system. When the plant is in operation, switching between the first fuel gas supply and the second fuel gas supply is performed via an automatic flow control system without impacting the production of hydrogen.

Optionally, the carbon dioxide capture device is an amine wash unit.

Optionally, the first fuel gas supply is a small burner header which is the only one used when the carbon dioxide capture device is in operation. The first fuel gas supply may be connected to staged burner tips while the second fuel gas supply is connected to a primary burner tip.

Optionally, the carbon dioxide capture device is fluidly connected to a bypass line that allows bypassing the carbon dioxide capture device completely or partially.

The first fuel gas supply is always in operation to its maximum extent, while the second fuel gas supply starts receiving flow when the carbon dioxide capture device is bypassed to certain extent.

Optionally, the first fuel gas supply of the at least one burner or the plurality of burners is configured to permit operation of the burner or burners with a fuel gas having a low flow rate, a low carbon dioxide concentration and a high lower heating value, and in that the second fuel gas supply of the at least one burner or the plurality of burners is configured to permit operation of the burner or burners with a fuel gas having a high flow rate, a high carbon dioxide concentration and a low lower heating value.

Optionally, the first fuel gas supply of the at least one burner or the plurality of burners is configured to permit operation of the burner or burners with a fuel gas having a first Wobbe index (IW1), and in that the second fuel gas supply of the at least one burner or the plurality of burners is configured to permit operation of the burner or burners with a fuel gas having a second Wobbe index (IW2), and in that means are comprised to allow that a ratio r between the two Wobbe indices (r=IW1/IW2) is set at larger than 1.8, preferably between 3 and 7, more preferably between 4.5 and 5.5.

Optionally, means are comprised which enable a third fuel gas containing hydrocarbons to be additionally supplied to the at least one burner or the plurality of burners and to be combusted with oxygen and/or air.

Optionally, means are comprised which enable the third fuel gas to be supplied to the at least one burner via the first fuel gas supply or the second fuel gas supply or a third fuel gas supply, preferably arranged on the same at least one burner or the same plurality of burners.

According to a fifth aspect, the present disclosure provides a method for revamping of a hydrogen production plant, wherein the hydrogen production plant comprises the following assemblies and components in fluid communication with each other:
(a) means for providing a feed gas stream containing gaseous or vaporized hydrocarbons, preferably natural gas or naphtha;
(b) a reforming stage, comprising a plurality of reformer tubes filled with a solid particulate reforming catalyst to produce a crude synthesis gas stream containing hydrogen, carbon monoxide, carbon dioxide and unreacted hydrocarbons, said reformer tubes being arranged in a reformer furnace, the interior of which is heated by means of at least one burner, preferably by a plurality of burners, by combusting at least two different fuel gases with oxygen and/or air, said at least one burner or plurality of burners comprising a first fuel gas supply and a second fuel gas supply on the same burner, means for introducing a first fuel gas stream into the first fuel gas supply and means for introducing a second fuel gas stream into the second fuel gas supply, means for adjusting the flow rates of the first fuel gas stream and the second fuel gas stream;
means for introducing the feed gas stream into the reforming stage;
means for discharging a crude synthesis gas stream from the reforming stage;
(c) a first cooling device, designed to allow cooling the crude synthesis gas stream in the first cooling device in indirect heat exchange with at least one coolant stream, means for introducing the crude synthesis gas stream into the first cooling device, means for discharging a cooled crude synthesis gas stream from the first cooling device;
(d) optionally, a CO shift plant comprising at least one CO shift stage, means for introducing at least a part of the cooled crude synthesis gas stream into the CO shift plant, means for discharging from the CO shift plant a shifted synthesis gas stream enriched in hydrogen and carbon dioxide and depleted in carbon monoxide relative to the crude synthesis gas stream;
(e) optionally, a second cooling device, designed to allow cooling the shifted synthesis gas stream in the second cooling device in indirect heat exchange with at least one coolant stream, means for introducing the shifted synthesis gas stream into the second cooling device, means for discharging a cooled shifted synthesis gas stream from the second cooling device; and
(f) a hydrogen enrichment device, operating on the principle of pressure swing adsorption (PSA), means for introducing the cooled crude synthesis gas stream from step (c) or the cooled shifted synthesis gas stream from optional steps (d) and (e) into the hydrogen enrichment device, means for discharging a hydrogen product stream and a PSA offgas stream from the hydrogen enrichment device, wherein the PSA offgas stream comprises hydrogen, carbon monoxide, carbon dioxide, and unreacted hydrocarbons;
   said method for revamping comprising the steps of:
(g) installing means for splitting the PSA offgas stream into a first partial PSA offgas stream and a second partial PSA offgas stream, installing means for setting the range of both the first partial PSA offgas stream and the second partial PSA offgas stream between and including 0 to 100 mol-% of the PSA offgas stream, and for setting the sum of the first partial PSA offgas stream and the second partial PSA offgas stream to equal the PSA offgas stream;
(h) installing a carbon dioxide capture device, designed to allow separating carbon dioxide from the first partial PSA offgas stream under carbon dioxide separation conditions, installing means for introducing the first partial PSA offgas stream into the carbon dioxide capture device, installing means for discharging a first carbon dioxide depleted partial PSA offgas stream and a carbon dioxide enriched offgas stream from the carbon dioxide capture device; and
(i) installing means for introducing at least a portion of the first carbon dioxide depleted partial PSA offgas stream as the first fuel gas stream into the first fuel gas supply of the at least one burner or the plurality of burners in the reformer furnace, and installing means for introducing at least a portion of the second partial PSA offgas stream as the second fuel gas stream into the second fuel gas supply of the at least one burner or the plurality of burners in the reformer furnace.

According to a sixth aspect, the present disclosure provides a method for revamping of a hydrogen production plant, wherein the hydrogen production plant comprises the following assemblies and components in fluid communication with each other:
(a) means for providing a feed gas stream containing gaseous or vaporized hydrocarbons, preferably natural gas or naphtha;
(b) a reforming stage, comprising a plurality of reformer tubes filled with a solid particulate reforming catalyst to produce a crude synthesis gas stream containing hydrogen, carbon monoxide, carbon dioxide and unreacted hydrocarbons, said reformer tubes being arranged in a reformer furnace, the interior of which is heated by means of at least one burner, preferably by a plurality of burners, by combusting at least two different fuel gases with oxygen and/or air, said at least one burner or plurality of burners comprising a first fuel gas supply and a second fuel gas supply on the same burner, means for introducing a first fuel gas stream into the first fuel gas supply and means for introducing a second fuel gas stream into the second fuel gas supply, means for adjusting the flow rates of the first fuel gas stream and the second fuel gas stream;
means for introducing the feed gas stream into the reforming stage;
means for discharging a crude synthesis gas stream from the reforming stage;
(c) a first cooling device, designed to allow cooling the crude synthesis gas stream in the first cooling device in indirect heat exchange with at least one coolant stream, means for introducing the crude synthesis gas stream into the first cooling device, means for discharging a cooled crude synthesis gas stream from the first cooling device;
(d) optionally, a CO shift plant comprising at least one CO shift stage, means for introducing at least a part of the cooled crude synthesis gas stream into the CO shift plant, means for discharging from the CO shift plant a shifted synthesis gas stream enriched in hydrogen and carbon dioxide and depleted in carbon monoxide relative to the crude synthesis gas stream;
(e) optionally, a second cooling device, designed to allow cooling the shifted synthesis gas stream in the second cooling device in indirect heat exchange with at least one coolant stream, means for introducing the shifted synthesis gas stream into the second cooling device, means for discharging a cooled shifted synthesis gas stream from the second cooling device; and
(f) a hydrogen enrichment device, operating on the principle of pressure swing adsorption (PSA), means for introducing the carbon dioxide depleted synthesis gas stream into the hydrogen enrichment device, means for discharging a hydrogen product stream and a PSA offgas stream from the hydrogen enrichment device, wherein the PSA offgas stream comprises hydrogen, carbon monoxide, carbon dioxide, and unreacted hydrocarbons;
   said method for revamping comprising the steps of:
(g) installing a carbon dioxide capture device, designed to allow separating carbon dioxide from the cooled shifted synthesis gas stream under carbon dioxide separation conditions, installing means for introducing the cooled crude synthesis gas stream from step (c) or the cooled shifted synthesis gas stream from optional steps (d) and (e) into the carbon dioxide capture device, installing means for discharging a carbon dioxide depleted synthesis gas stream and a carbon dioxide offgas stream from the carbon dioxide capture device;
(h) installing means for splitting the PSA offgas stream into a first partial PSA offgas stream and a second partial PSA offgas stream, installing means for setting the range of both the first partial PSA offgas stream and the second partial PSA offgas stream between and including 0 to 100 mol-% of the PSA offgas stream, and for setting the sum of the first partial PSA offgas stream and the second partial PSA offgas stream to equal the PSA offgas stream; and
(i) installing means for introducing at least a portion of the first partial PSA offgas stream as the first fuel gas stream into the first fuel gas supply of the at least one burner or the plurality of burners in the reformer furnace, and installing means for introducing at least a portion of the second partial PSA offgas stream as the second fuel gas stream into the second fuel gas supply of the at least one burner or the plurality of burners in the reformer furnace.

The method for revamping of the hydrogen production plant according to the present disclosure is of advantage in that the method enables to produce low-carbon hydrogen continuously in an existing hydrogen production plant even when the carbon dioxide capture device is not in operation.

Below table 1 illustrates two operating scenarios of the carbon dioxide capture device such as in full-operation and shut down, for production of hydrogen.

Embodiments of the present disclosure substantially eliminate or at least partially address the aforementioned technical drawbacks in existing technologies for hydrogen production by using the burner system with at least two fuel gas supply to accommodate different streams of PSA offgas, thereby enabling continuous production of low-carbon hydrogen even when the carbon dioxide capture device is not in operation and also minimizing NOx emissions.

TABLE 1
Two operating scenarios of the carbon dioxide
capture device for production of hydrogen

| Parameters | Units | Case 1 | Case 2 |
|---|---|---|---|
| Carbon dioxide capture | — | Yes | No |
| device running | | | |
| Hydrogen production | % | 100 | 100 |
| PSA offgas stream flow | mol/mol | 100 | 650 |
| rate | | | |
| Carbon dioxide content | % mol | 6 | 55 |
| in PSA offgas stream | | | |
| Fraction of PSA offgas | % | 100 | 5-10 |
| stream to first fuel gas | | | |
| supply | | | |
| Fraction of PSA offgas | % | 0 | 90-95 |
| stream to second fuel | | | |
| gas supply | | | |

### DETAILED DESCRIPTION OF THE DRAWINGS

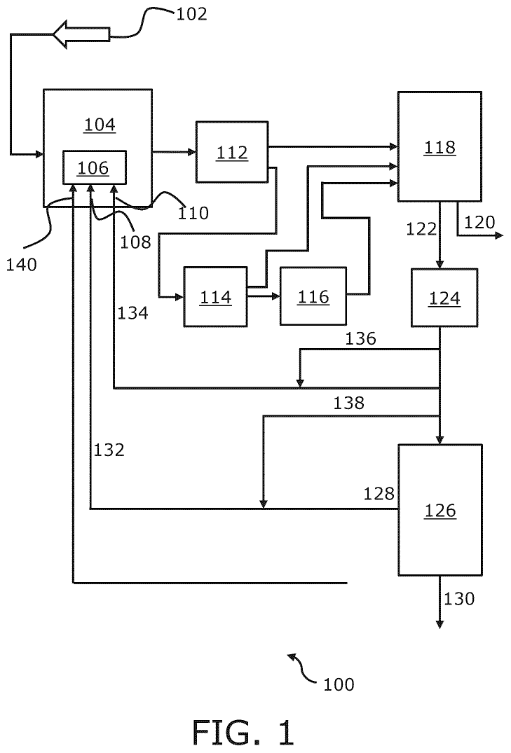

FIG. 1 is a block diagram of a plant 100 for producing hydrogen by steam reforming of a hydrocarbon-containing feed gas where a carbon dioxide capture device 126 is arranged downstream to a hydrogen enrichment device 118 according to an embodiment of the present disclosure. The plant 100 comprises a feed gas providing means 102, a reformer furnace 104 that comprises a plurality of reformer tubes filled with a solid particulate reforming catalyst, a first cooling device 112, an optional carbon monoxide (CO) shift plant 114, an optional second cooling device 116, a hydrogen enrichment device 118, a splitting means 124, a range setting means (not shown in FIG. 1) and a carbon dioxide capture device 126. The feed gas providing means 102 provides feed gas stream containing gaseous or vaporized hydrocarbons, preferably natural gas or naphtha. The feed gas stream is introduced to a reforming stage via introducing means. In the reforming stage, the feed gas stream is introduced by introducing means (not shown in FIG. 1) into the plurality of reformer tubes and reacted under steam reforming conditions in the plurality of reformer tubes to produce a crude synthesis gas stream containing hydrogen, carbon monoxide, carbon dioxide and unreacted hydrocarbons. The crude synthesis gas stream is discharged by discharging means from the reforming stage. The plurality of reformer tubes are arranged in the reformer furnace 104, the interior of which is heated by means of at least one burner 106, preferably by a plurality of burners, by combusting at least two different fuel gases with oxygen and/or air. The at least one burner 106 or plurality of burners comprises a first fuel gas supply 108 and a second fuel gas supply 110 on the same burner 106. The burner 106 or plurality of burners further includes means for introducing a first fuel gas stream into the first fuel gas supply 108, means for introducing a second fuel gas stream into the second fuel gas supply 110, and means for adjusting the flow rates of the first fuel gas stream and the second fuel gas stream (not shown). The crude synthesis gas stream is discharged from the reforming stage via discharging means. The crude synthesis gas stream is introduced by introducing means into the first cooling device 112. The first cooling device 112 is designed to allow cooling the crude synthesis gas stream in the first cooling device 112 in indirect heat exchange with at least one coolant stream. Cooled crude synthesis gas stream is discharged by discharging means from the first cooling device 112. At least a part of the cooled crude synthesis gas stream is introduced by introducing means into the CO shift plant 114. The CO shift plant 114 is designed to shift carbon monoxide (CO) in the cooled crude synthesis gas stream into carbon dioxide and hydrogen as useful components. A shifted synthesis gas stream enriched in carbon dioxide and hydrogen and depleted in CO relative to the crude synthesis gas stream is discharged by discharging means from the CO shift plant 114. The shifted synthesis gas stream is introduced by introducing means into the second cooling device 116. The second cooling device 116 is designed to allow cooling the shifted synthesis gas stream in the second cooling device 116 in indirect heat exchange with at least one coolant stream. Cooled shifted synthesis gas stream is discharged by discharging means from the second cooling device 116. The cooled crude synthesis gas stream from the first cooling device 112 and/or the cooled shifted synthesis gas stream from the optional CO shift plant 114 and second cooling device 116 is introduced by introducing means into the hydrogen enrichment device 118. The hydrogen enrichment device 118 is operating on the principle of pressure swing adsorption (PSA) to recover and purify hydrogen. A hydrogen product stream is discharged by discharging means 120 from the hydrogen enrichment device 118. A PSA offgas stream is discharged by discharging means 122 from the hydrogen enrichment device 118. The PSA offgas stream comprises hydrogen, carbon monoxide, carbon dioxide, and unreacted hydrocarbons. The splitting means 124 is designed to split the PSA offgas stream into a first partial PSA offgas stream and a second partial PSA offgas stream. The range setting means is designed to set the range of both the first partial PSA offgas stream and the second partial PSA offgas stream between and including 0 to 100 mol-% of the PSA offgas stream, and set the sum of the first partial PSA offgas stream and the second partial PSA offgas stream to equal the PSA offgas stream. The first partial PSA offgas stream is introduced by introducing means into the carbon dioxide capture device 126. The carbon dioxide capture device 126 is designed to allow separating carbon dioxide from the first partial PSA offgas stream under carbon dioxide separation conditions. A first carbon dioxide depleted partial PSA offgas stream is discharged by means 128 from the carbon dioxide capture device 126. A carbon dioxide enriched offgas stream is discharged by means 130 from the carbon dioxide capture device 126. At least a portion of the first carbon dioxide depleted partial PSA offgas stream as the first fuel gas stream is introduced by introducing means 132 into the first fuel gas supply 108 of the at least one burner 106 or the plurality of burners in the reformer furnace 104. At least a portion of the second partial PSA offgas stream as the second fuel gas stream is introduced by introducing means 134 into the second fuel gas supply 110 of the at least one burner 106 or the plurality of burners in the reformer furnace 104. The carbon dioxide capture device 126 is fluidly connected to bypass line 136 and 138 that allow bypassing the carbon dioxide capture device 126 completely or partially.

The first fuel gas supply 108 is configured to permit operation of the burner 106 or burners with a fuel gas having a low flow rate, a low carbon dioxide concentration and a high lower heating value. The second fuel gas supply 110 is configured to permit operation of the burner 106 or burners with a fuel gas having a high flow rate, a high carbon dioxide concentration and a low lower heating value. The first fuel gas supply 108 is configured to permit operation of the burner 106 or burners with a fuel gas having a first Wobbe index (IW1). The second fuel gas supply 110 is configured to permit operation of the burner 106 or burners with a fuel gas having a second Wobbe index (IW2), and in that means are comprised to allow that a ratio r between the two Wobbe indices (r=IW1/IW2) is set at larger than 1.8, preferably between 3 and 7, more preferably between 4.5 and 5.5. The burner 106 or plurality of burners further includes means to enable a third fuel gas containing hydrocarbons to be additionally supplied to the at least one burner 106 or the plurality of burners via the first fuel gas supply 108 or the second fuel gas supply 110 or a third fuel gas supply 140, preferably arranged on the same at least one burner 106 or the same plurality of burners and to be combusted with oxygen and/or air.

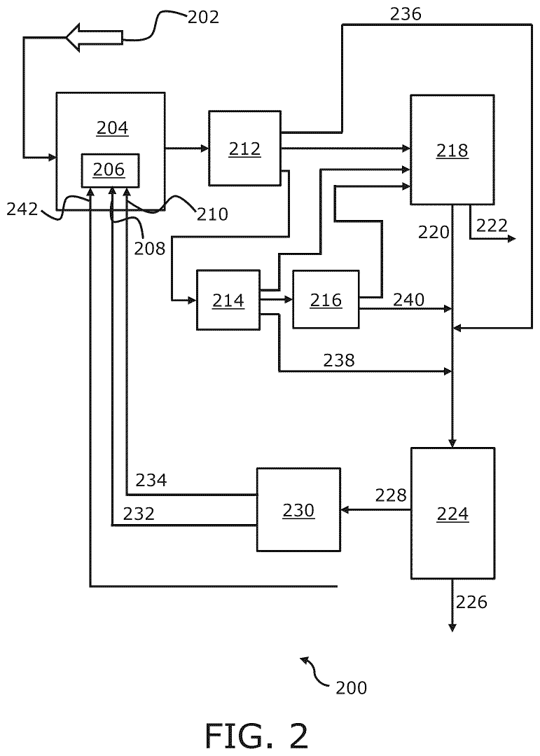

FIG. 2 is a block diagram of a plant 200 for producing hydrogen by steam reforming of a hydrocarbon-containing feed gas where a carbon dioxide capture device 218 is arranged upstream to a hydrogen enrichment device 224 according to an embodiment of the present disclosure. The plant 200 comprises a feed gas providing means 202, a reformer furnace 204 that comprises a plurality of reformer tubes filled with a solid particulate reforming catalyst, a first cooling device 212, an optional carbon monoxide (CO) shift plant 214, an optional second cooling device 216, a carbon dioxide capture device 218, a hydrogen enrichment device 224, a splitting means 230, a range setting means (not shown in FIG. 2). The feed gas providing means 202 provides feed gas stream containing gaseous or vaporized hydrocarbons, preferably natural gas or naphtha. The feed gas stream is introduced to a reforming stage via introducing means. In the reforming stage, the feed gas stream is introduced by introducing means into the plurality of reformer tubes and reacted under steam reforming conditions in the plurality of reformer tubes to produce a crude synthesis gas stream containing hydrogen, carbon monoxide, carbon dioxide and unreacted hydrocarbons. The crude synthesis gas stream is discharged by discharging means from the reforming stage. The plurality of reformer tubes are arranged in the reformer furnace 204, the interior of which is heated by means of at least one burner 206, preferably by a plurality of burners, by combusting at least two different fuel gases with oxygen and/or air. The burner 206 or plurality of burners comprises a first fuel gas supply 208 and a second fuel gas supply 210 on the same burner 206. The burner 206 or plurality of burners further includes means for introducing a first fuel gas stream into the first fuel gas supply 208, means for introducing a second fuel gas stream into the second fuel gas supply 210, and means for adjusting the flow rates of the first fuel gas stream and the second fuel gas stream (not shown). The crude synthesis gas stream is discharged from the reforming stage via discharging means. The crude synthesis gas stream is introduced by introducing means into the first cooling device 212. The first cooling device 212 is designed to allow cooling the crude synthesis gas stream in the first cooling device 212 in indirect heat exchange with at least one coolant stream. Cooled crude synthesis gas stream is discharged by discharging means from the first cooling device 212. At least a part of the cooled crude synthesis gas stream is introduced by introducing means into the CO shift plant 214. The CO shift plant 214 is designed to shift carbon monoxide (CO) in the cooled crude synthesis gas stream into carbon dioxide and hydrogen as useful components. A shifted synthesis gas stream enriched in carbon dioxide and hydrogen and depleted in CO relative to the crude synthesis gas stream is discharged by discharging means from the CO shift plant 214. The shifted synthesis gas stream is introduced by introducing means into the second cooling device 216. The second cooling device 216 is designed to allow cooling the shifted synthesis gas stream in the second cooling device 216 in indirect heat exchange with at least one coolant stream. Cooled shifted synthesis gas stream is discharged by discharging means from the second cooling device 216. The cooled crude synthesis gas stream from the first cooling device 212 and/or the cooled shifted synthesis gas stream from the optional CO shift plant 214 and second cooling device 216 is introduced by introducing means into the carbon dioxide capture device 218. The carbon dioxide capture device 218 is designed to allow separating carbon dioxide from the cooled shifted synthesis gas stream under carbon dioxide separation conditions. A carbon dioxide depleted synthesis gas stream is discharged by discharging means 220 from the carbon dioxide capture device 218. A carbon dioxide offgas stream is discharged by discharging means 222 from the carbon dioxide capture device 218. The carbon dioxide depleted synthesis gas stream is introduced by introducing means into the hydrogen enrichment device 224. The hydrogen enrichment device 224 is operating on the principle of pressure swing adsorption (PSA) to recover and purify hydrogen. A hydrogen product stream is discharged by discharging means 226 from the hydrogen enrichment device 224. A PSA offgas stream is discharged by discharging means 228 from the hydrogen enrichment device 224. The PSA offgas stream comprises hydrogen, carbon monoxide, carbon dioxide, and unreacted hydrocarbons. The splitting means 230 is designed to split the PSA offgas stream into a first partial PSA offgas stream and a second partial PSA offgas stream. The range setting means is designed to set the range of both the first partial PSA offgas stream and the second partial PSA offgas stream between and including 0 to 100 mol-% of the PSA offgas stream, and set the sum of the first partial PSA offgas stream and the second partial PSA offgas stream to equal the PSA offgas stream. At least a portion of the first partial PSA offgas stream as the first fuel gas stream is introduced by introducing means 232 into the first fuel gas supply 208 of the at least one burner 206 or the plurality of burners in the reformer furnace 204.

At least a portion of the second partial PSA offgas stream as the second fuel gas stream is introduced by introducing means 234 into the second fuel gas supply 210 of the at least one burner 206 or the plurality of burners in the reformer furnace 204. The carbon dioxide capture device 218 is fluidly connected to bypass lines 236, 238, 240 that allow bypassing the carbon dioxide capture device 218 completely or partially.

The first fuel gas supply 208 is configured to permit operation of the burner 206 or burners with a fuel gas having a low flow rate, a low carbon dioxide concentration and a high lower heating value. The second fuel gas supply 210 is configured to permit operation of the burner 206 or burners with a fuel gas having a high flow rate, a high carbon dioxide concentration and a low lower heating value. The first fuel gas supply 208 is configured to permit operation of the burner 206 or burners with a fuel gas having a first Wobbe index (IW1). The second fuel gas supply 210 is configured to permit operation of the burner 206 or burners with a fuel gas having a second Wobbe index (IW2), and in that means are comprised to allow that a ratio r between the two Wobbe indices (r=IW1/IW2) is set at larger than 1.8, preferably between 3 and 7, more preferably between 4.5 and 5.5. The burner 206 or plurality of burners further includes means to enable a third fuel gas containing hydrocarbons to be additionally supplied to the at least one burner 206 or the plurality of burners via the first fuel gas supply 208 or the second fuel gas supply 210 or a third fuel gas supply 242, preferably arranged on the same at least one burner 206 or the same plurality of burners and to be combusted with oxygen and/or air.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

### LIST OF REFERENCE NUMERALS

100, 200—plant or hydrogen production plant
102, 202—feedgas providing means
104, 204—reformer furnace
106, 206—burner
108, 208—first fuel gas supply
110, 210—second fuel gas supply
112, 212—first cooling device
114, 214—CO shift plant
116, 216—second cooling device
118, 224—hydrogen enrichment device
120, 226—hydrogen discharging means
122, 228—PSA offgas discharging means
124, 230—splitting means
126, 218—carbon dioxide capture device
128—first carbon dioxide depleted partial PSA offgas stream discharging means
130—carbon dioxide enriched offgas stream discharging means
132—first carbon dioxide depleted partial PSA offgas stream introducing means
134, 234—second partial PSA offgas stream introducing means
136, 138, 236, 238, 240—bypass line
140, 242—third fuel gas supply
220—carbon dioxide depleted synthesis gas stream discharging means
222—carbon dioxide offgas stream discharging means
232—first partial PSA offgas stream introducing means

1-18. (canceled)

19. A process for producing hydrogen by steam reforming of a hydrocarbon-containing feed gas, comprising the following steps:
(a) providing a feed gas stream containing gaseous or vaporized hydrocarbons;
(b) introducing the feed gas stream into a reforming stage, reacting the feed gas stream in the reforming stage under steam reforming conditions in a plurality of reformer tubes filled with a solid particulate reforming catalyst to produce a crude synthesis gas stream containing hydrogen, carbon monoxide, carbon dioxide, and unreacted hydrocarbons, said reformer tubes being arranged in a reformer furnace, the interior of which is heated by one or more burners, combusting at least two fuel gases with oxygen and/or air, said at least one or more burners comprising a first fuel gas supply and a second fuel gas supply on the same one or more burners, wherein a first fuel gas is introduced into the first fuel gas supply and a second fuel gas is introduced into the second fuel gas supply; wherein a flow rate of the first fuel gas stream and flow rate of the second fuel gas stream are adjustable;
(c) discharging the crude synthesis gas stream from the reforming stage and introducing the crude synthesis gas stream into a first cooling device, cooling the crude synthesis gas stream in the first cooling device in indirect heat exchange with at least one coolant stream, discharging a cooled crude synthesis gas stream from the first cooling device;
(d) optionally, introducing at least a part of the cooled crude synthesis gas stream into a CO shift plant comprising at least one CO shift stage, converting the cooled crude synthesis gas stream introduced into the CO shift plant under CO shift conditions to a shifted synthesis gas stream, discharging the shifted synthesis gas stream enriched in hydrogen and carbon dioxide and depleted in carbon monoxide relative to the crude synthesis gas stream;
(e) optionally, introducing the shifted synthesis gas stream into a second cooling device, cooling the shifted synthesis gas stream in the second cooling device in indirect heat exchange with a second coolant stream, discharging a cooled shifted synthesis gas stream from the second cooling device;
(f) introducing the cooled crude synthesis gas stream from step (c) or the cooled shifted synthesis gas stream from optional steps (d) and (e) into a hydrogen enrichment device, operating on the principle of pressure swing adsorption (PSA), discharging a hydrogen product stream and a PSA offgas stream from the hydrogen enrichment device, wherein the PSA offgas stream comprises hydrogen, carbon monoxide, carbon dioxide, and unreacted hydrocarbons;
(g) splitting the PSA offgas stream into a first partial PSA offgas stream and a second partial PSA offgas stream, wherein the first partial PSA offgas stream and the second partial PSA offgas stream both range between and including 0 to 100 mol-% of the PSA offgas stream, and the sum of the first partial PSA offgas stream and the second partial PSA offgas stream equals the PSA offgas stream;
(h) introducing the first partial PSA offgas stream into a carbon dioxide capture device, separating carbon dioxide from the first partial PSA offgas stream, discharging a first carbon dioxide depleted partial PSA offgas stream and a carbon dioxide enriched offgas stream from the carbon dioxide capture device; and
(i) introducing at least a portion of the first carbon dioxide depleted partial PSA offgas stream as the first fuel gas stream into the first fuel gas supply of the one or more burners in the reformer furnace, and introducing at least a portion of the second partial PSA offgas stream as the second fuel gas stream into the second fuel gas supply of the one or more burners or in the reformer furnace.

20. A process for producing hydrogen by steam reforming of a hydrocarbon-containing feed gas, comprising the following steps:
(a) providing a feed gas stream containing gaseous or vaporized hydrocarbons;
(b) introducing the feed gas stream into a reforming stage, reacting the feed gas stream in the reforming stage under steam reforming conditions in a plurality of reformer tubes filled with a solid particulate reforming catalyst to produce a crude synthesis gas stream containing hydrogen, carbon monoxide, carbon dioxide, and unreacted hydrocarbons, said reformer tubes being arranged in a reformer furnace, the interior of which is heated by one or more burners combusting at least two fuel gases with oxygen and/or air, said one or more burners comprising a first fuel gas supply and a second fuel gas supply on the same one or more burners, wherein a first fuel gas is introduced into the first fuel gas supply and a second fuel gas is introduced into the second fuel gas supply; wherein a flow rate of the first fuel gas stream and a flow rate of the second fuel gas stream are adjustable;
(c) discharging the crude synthesis gas stream from the reforming stage and introducing the crude synthesis gas stream into a first cooling device, cooling the crude synthesis gas stream in the first cooling device in indirect heat exchange with at least one coolant stream, discharging a cooled crude synthesis gas stream from the first cooling device;
(d) optionally, introducing at least a part of the cooled crude synthesis gas stream into a CO shift plant comprising at least one CO shift stage, converting the cooled crude synthesis gas stream introduced into the CO shift plant under CO shift conditions to a shifted synthesis gas stream, discharging the shifted synthesis gas stream enriched in hydrogen and carbon dioxide and depleted in carbon monoxide relative to the crude synthesis gas stream;
(e) optionally, introducing the shifted synthesis gas stream into a second cooling device, cooling the shifted synthesis gas stream in the second cooling device in indirect heat exchange with a second coolant stream, discharging a cooled shifted synthesis gas stream from the second cooling device;
(f) introducing the cooled crude synthesis gas stream from step (c) or the cooled shifted synthesis gas stream from optional steps (d) and (e) into a carbon dioxide capture device, separating carbon dioxide from the cooled crude synthesis gas stream or from the cooled shifted synthesis gas stream, discharging a carbon dioxide depleted synthesis gas stream and a carbon dioxide enriched offgas stream from the carbon dioxide capture device;
(g) introducing the carbon dioxide depleted synthesis gas stream into a hydrogen enrichment device, operating on the principle of pressure swing adsorption (PSA), discharging a hydrogen product stream and a PSA offgas stream from the hydrogen enrichment device, wherein the PSA offgas stream comprises hydrogen, carbon monoxide, carbon dioxide, and unreacted hydrocarbons;
(h) splitting the PSA offgas stream into a first partial PSA offgas stream and a second partial PSA offgas stream, wherein the first partial PSA offgas stream and the second partial PSA offgas stream both range between and including 0 to 100 mol-% of the PSA offgas stream, and the sum of the first partial PSA offgas stream and the second partial PSA offgas stream equals the PSA offgas stream; and
(i) introducing at least a portion of the first partial PSA offgas stream as the first fuel gas stream into the first fuel gas supply of the one or more burners in the reformer furnace, and introducing at least a portion of the second partial PSA offgas stream as the second fuel gas stream into the second fuel gas supply of the one or more burners in the reformer furnace.

21. The process according to claim 19, characterized in that the carbon dioxide capture device can be bypassed completely or partially.

22. The process according to claim 19, characterized in that
the first fuel gas supply of the one or more burners is configured to permit operation with a fuel gas having a first fuel gas supply flow rate, a first fuel gas supply carbon dioxide concentration and a first fuel gas supply heating value, and in that
the second fuel gas supply of the one or more burners is configured to permit operation with a fuel gas having a second fuel gas supply flow rate, a second fuel gas supply carbon dioxide concentration and a second fuel gas supply heating value, wherein the second fuel gas supply flow rate, carbon dioxide concentration and heating value are each greater than the first fuel gas supply flow rate, carbon dioxide concentration and heating value.

23. The process according to claim 19, characterized in that
the first fuel gas supply of the one or more burners are configured to permit operation of the one or more burners with a fuel gas having a first Wobbe index (IW1),
and in that
the second fuel gas supply of the one or more burners is configured to permit operation of the one or more burners with a fuel gas having a second Wobbe index (IW2), and in that a ratio r between the two Wobbe indices (r=IW1/IW2) is larger than 1.8, preferably between 3 and 7, more preferably between 4.5 and 5.5.

24. The process according to claim 19, characterized in that, when the process is carried out with the carbon dioxide capture device in full-load operation, the entire first fuel gas stream is introduced into the first fuel gas supply, whereas only a part of the second fuel gas stream is introduced into the second fuel gas supply, corresponding to a fraction of less than 1 of its full flow to zero.

25. The process according to claim 19, characterized in that, when the process is carried out with the carbon dioxide capture device in partial-load operation or with the carbon dioxide capture device being shut down, the entire second fuel gas stream is introduced into the second fuel gas supply, whereas only a part of the first fuel gas stream is introduced into the first fuel gas supply, corresponding to a fraction of less than 1 of its full flow or zero.

26. The process according to claim 19, characterized in that a third fuel gas containing hydrocarbons is additionally supplied to the one or more burners and combusted with oxygen and/or air.

27. The process according to claim 26, characterized in that the third fuel gas is supplied to the one or more burners via the first fuel gas supply and/or the second fuel gas supply and/or a third fuel gas supply.
